(19) United States
(12) Patent Application Publication
(10) Pub. No.: US 2009/0327950 A1
(43) Pub. Date: Dec. 31, 2009

(54) SYSTEM AND METHOD FOR SCROLLING THROUGH AN ELECTRONIC DOCUMENT IN A MOBILE DEVICE

(75) Inventor: LUN-YI Kuo, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/334,529

(22) Filed: Dec. 15, 2008

(30) Foreign Application Priority Data
Jun. 26, 2008 (CN) 200810302330.0

(51) Int. Cl. G06F 3/00

(52) U.S. Cl. 715/784

(57) ABSTRACT

A system and method for scrolling through an electronic document in a mobile device captures successive images of an outside environment corresponding to a movement of the mobile device. The system and method analyzes the successive images for computing motion vectors of the mobile device, and scrolls through the electronic document according to the motion vectors for refreshing a frame of the electronic document displayed on a screen of the mobile device.

### BACKGROUND

1. Technical Field

Embodiments of the present disclosure generally relate to systems and methods for reading documents, and more particularly, to a system and method for scrolling through an electronic document in a mobile device.

2. Description of Related Art

Mobile devices, such as mobile telephones, are widely used because of their multi-functional services and other conveniences. A mobile phone can help people keep in contact with family and friends, and also can be used as a dictionary, a media player, an E-reader, and so on.

When people read an electronic document, such as a text shown in FIG. 1, which is displayed on a screen of a mobile phone, the content of the electronic document cannot be displayed completely at one time due to the size of the screen, as shown in FIG. 2A. As a result, people need to press directional keys or touch the screen of the mobile phone, to scroll through the electronic document, for reading the full content of the electronic document, as shown in FIG. 2B. However, if the electronic document is very long, it will be tiresome for people to keep pressing the directional keys or touching the screen.

What is needed, therefore, is a system and a method for conveniently scrolling though an electronic document in a mobile device.

### BRIEF DESCRIPTION OF THE DRAWINGS

FIG. 1 illustrates an electronic document in a mobile device;

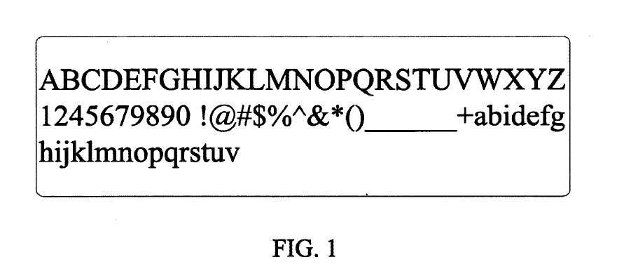

FIG. 2A and FIG. 2B illustrate two interfaces that show different frames of the electronic document by scrolling through the electronic document;

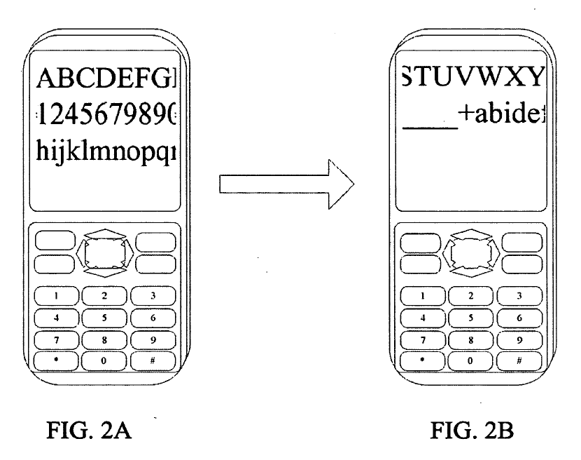

FIG. 3 is a block diagram of one embodiment of a system for scrolling through an electronic document in a mobile device; and

FIG. 4 is a flowchart illustrating one embodiment of a method for scrolling through an electronic document in a mobile device.

### DETAILED DESCRIPTION OF CERTAIN INVENTIVE EMBODIMENTS

All of the processes described below may be embodied in, and fully automated via, functional modules executed by one or more general purpose processors. The functional modules may be stored in any type of computer-readable medium or other computer storage device. Some or all of the methods may alternatively be embodied in specialized computer hardware or communication apparatus.

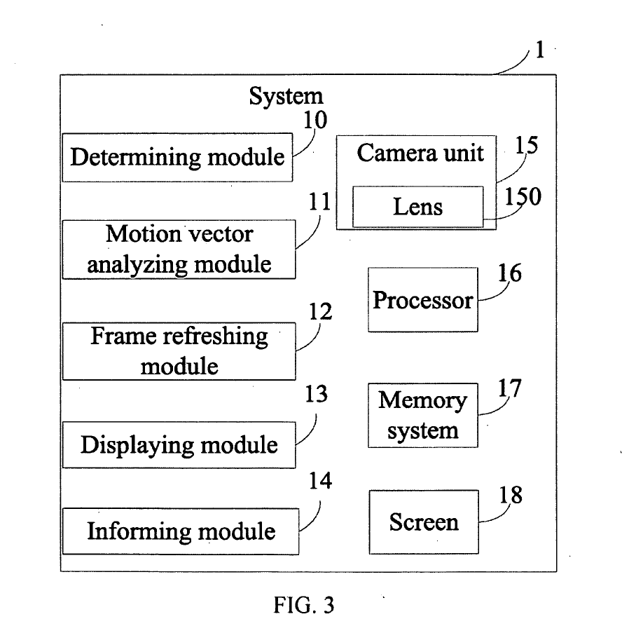

FIG. 3 is a block diagram of one embodiment of a system 1 for scrolling through an electronic document in a mobile device. The mobile device may be a mobile phone having image capture abilities, a digital camera, or the like. The system 1 includes a determining module 10, a motion vector analyzing module 11, a frame refreshing module 12, a displaying module 13, an informing module 14, and a camera unit 15. It may be understood that, one or more specialized or general purpose processors, such as a processor 16, in the system 1 may be used to execute the function modules 10, 11, 12, 13, and 14. It may be further understood that, one or more memory systems, such as a memory system 17, may be installed in the system 1 for storing the electronic document, and data needed or generated during scrolling through the electronic document. The system 1 may further include a screen 18, which is used for displaying the electronic document.

The determining module 10 is configured for determining if the electronic document needs to be scrolled through based on an operation of a user.

The camera unit 15 captures successive images of an outside environment that is in the viewing area of a lens 150 of the camera unit 15 corresponding to a movement of the mobile device, such as an upwards, downwards, or back and forth movement if the electronic document needs to be scrolled through.

The motion vector analyzing module 11 is configured for analyzing the successive images for computing motion vectors of the mobile device. In one embodiment, the motion vector analyzing module 11 compares a first image and a last image of the successive images for obtaining a direction of the movement of the mobile device. Furthermore, the motion vector analyzing module 11 computes a horizon distance between the first image and the last image, and obtains the times of capturing the first image and the last image, for calculating a speed of the movement of the mobile device.

The frame refreshing module 12 is configured for scrolling through the electronic document according to the speed and the direction of the movement, which determines when a frame of the electronic document displayed on the screen 18 of the mobile device is refreshed to show a next section of the electronic document.

The displaying module 13 is configured for displaying a refreshed frame of the electronic document on the screen 18 of the mobile device.

The informing module 14 is configured for informing that the electronic document comes to the end if the bottom margin of the electronic document has been reached.

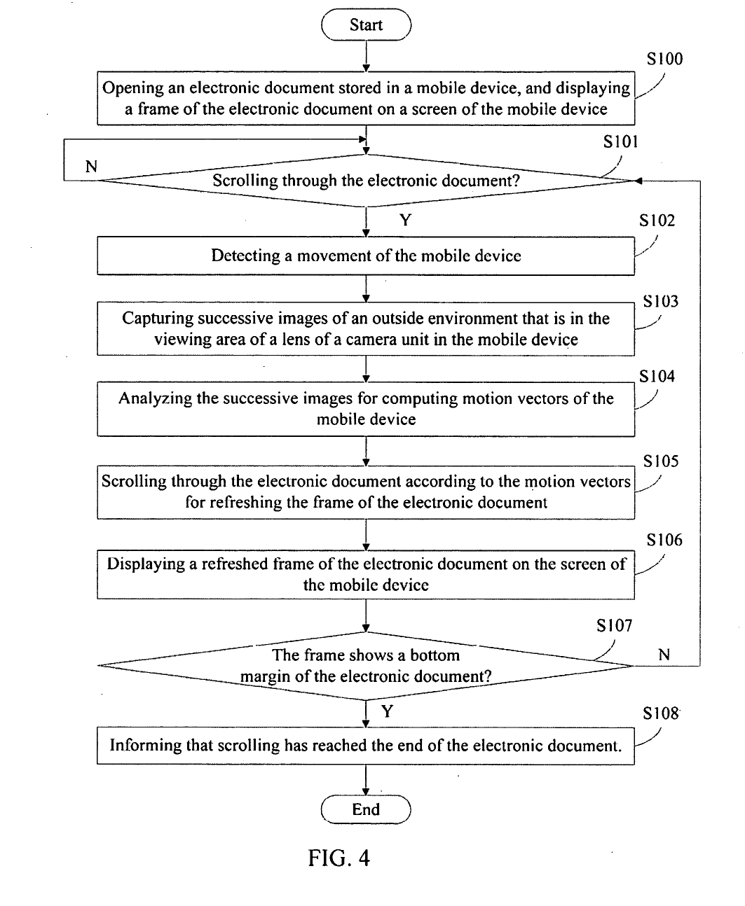

FIG. 4 is a flowchart illustrating one embodiment of a method for scrolling through an electronic document in a mobile device. Depending on the embodiment, additional blocks in the flow of FIG. 4 may be added, others removed, and the ordering of the blocks may be changed.

In block S100, an electronic document stored in the memory system 17 is opened, thus, a frame of the electronic document is displayed on the screen 18 of the mobile device.

In block S101, the determining module 10 determines if the electronic document needs to be scrolled through based on an operation of a user. If the electronic document does not need to be scrolled, the flow returns to block S101. If the electronic document does need to be scrolled, the flow moves on to block S102.

In block S102, the camera unit 15 detects a movement of the mobile device. The movement of the mobile device may occur when the user moves the mobile device in a predetermined manner, such as a short rapid up and down or back and forth movement. For example, when the user wants to scroll down the electronic document, he may move the mobile device downwards. In another example, the user may move the mobile device upwards to scroll up the electronic document. It may be understood that, the movement has been previously associated with command to scroll to a next frame of the electronic document.

In block S103, the camera unit 15 captures successive images of an outside environment that is in the viewing area of the lens 150 of the camera unit 15 corresponding to the movement of the mobile device

In block S104, the motion vector analyzing module 11 analyzes the successive images, for computing motion vectors of the mobile device. As mentioned above, the motion vector analyzing module 11 compares a first image and a last image of the successive images for obtaining a direction of the movement of the mobile device. Furthermore, the motion vector analyzing module 11 computes a horizon distance between the first image and the last image, and obtains the times of capturing the first image and the last image, thus, a speed of the movement of the mobile device can be calculated.

In block S105, the frame refreshing module 12 scrolls through the electronic document according to the calculated direction and speed of the mobile device, for refreshing the frame of the electronic document displayed on the screen 18 of the mobile device.

In block S106, the displaying module 13 displays a refreshed frame of the electronic document on the screen 18 of the mobile device.

In block S107, the informing module 14 determines if the frame shows the a margin, for example the bottom margin, of the electronic document. If the frame shows the bottom margin of the electronic document, the flow moves to block S108. Otherwise, the flow returns to block S101 described above.

In block S108, the informing module 14 informs the user that scrolling has reached the end of the electronic document.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for scrolling through an electronic document in a mobile device, the system comprising:
a camera unit that captures successive images of an outside environment that is in the viewing area of a lens of the camera unit corresponding to a movement of the mobile device;
a motion vector analyzing module configured for analyzing the successive images for computing motion vectors of the mobile device;
a frame refreshing module configured for scrolling through the electronic document according to the motion vectors for refreshing a frame of the electronic document displayed on a screen of the mobile device;
a displaying module configured for displaying a refreshed frame of the electronic document on the screen of the mobile device; and
at least one processor that executes the motion vector analyzing module, the frame refreshing module, and the displaying module.

2. The system as described in claim 1, the system further comprising:
a memory system for storing the electronic document.

3. The system as described in claim 1, wherein the mobile device is a mobile phone or a digital camera.

4. The system as described in claim 1, wherein the movement is an upwards, downwards, or back and forth movement.

5. The system as described in claim 1, wherein the motion vector comprise a direction and a speed of the movement.

6. The system as described in claim 5, wherein the direction is computed by comparing a first image and a last image of the successive images.

7. The system as described in claim 5, wherein the speed is computed by obtaining a horizon distance between a first image and a last image of the successive images, and the time of capture of the first image and the last image.

8. The system as described in claim 1, the system further comprising:
an informing module configured for informing that the electronic document comes to the end if the bottom margin of the electronic document has been reached.

9. A method for scrolling through an electronic document in a mobile device, the mobile device comprising a camera unit, the method comprising:
opening the electronic document stored in a storage system of the mobile device, and displaying a frame of the electronic document on a screen of the mobile device;
capturing successive images of an outside environment that is in the viewing area of a lens of the camera unit corresponding to a movement of the mobile device;
analyzing the successive images for computing motion vectors of the mobile device;
scrolling through the electronic document according to the motion vectors for refreshing the frame of the electronic document; and
displaying a refreshed frame of the electronic document.

10. The method as described in claim 9, wherein the mobile device is a mobile phone or a digital camera.

11. The method as described in claim 9, wherein the movement is an upwards, downwards, or back and forth movement.

12. The method as described in claim 9, wherein the motion vector comprise a direction and a speed of the movement.

13. The method as described in claim 12, wherein the analyzing block comprises:
computing the direction by comparing a first image and a last image of the successive images; and
computing the speed by obtaining a horizon distance between the first image and the last image, and obtaining the time of capture of the first image and the last image.

14. The method as described in claim 9, further comprising:
determining that if the frame shows a bottom margin of the electronic document; and
informing that the electronic document comes to the end upon the condition that the frame shows a bottom margin of the electronic document.

15. A storage medium having stored thereon instructions that, when executed by a processor, causing the processor to perform a method for scrolling through an electronic document in a mobile device, the method comprising:
opening the electronic document stored in a storage system of the mobile device, and displaying a frame of the electronic document on a screen of the mobile device;
capturing successive images of an outside environment that is in the viewing area of a lens of the camera unit corresponding to a movement of the mobile device;
analyzing the successive images for computing motion vectors of the mobile device;
scrolling through the electronic document according to the motion vectors for refreshing the frame of the electronic document; and
displaying a refreshed frame of the electronic document.

16. The storage medium as described in claim 15, wherein the mobile device is a mobile phone or a digital camera.

17. The storage medium as described in claim 15, wherein the movement is an upwards, downwards, or back and forth movement.

18. The storage medium as described in claim 15, wherein the motion vector comprise a direction and a speed of the movement.

19. The storage medium as described in claim 18, wherein the analyzing block comprises:
computing the direction by comparing a first image and a last image of the successive images; and
computing the speed by obtaining a horizon distance between the first image and the last image, and obtaining the time of capture of the first image and the last image.

20. The method as described in claim 15, further comprising:
determining that whether the frame shows a bottom margin of the electronic document; and
informing that the electronic document comes to the end upon the condition that the frame shows a bottom margin of the electronic document.
